(19) United States
(12) Patent Application Publication
(10) Pub. No.: US 2016/0202788 A1
(43) Pub. Date: Jul. 14, 2016

(54) MULTI-ON-BODY ACTION DETECTION BASED ON ULTRASOUND

(71) Applicant: Sony Corporation, Tokyo (JP)

(72) Inventors: Alexander Hunt, Tygelsjo (SE); Andreas Kristensson, Sondra Sandby (SE); Magnus Landqvist, Lund (SE); Ola Thörn, Limhamn (SE)

(73) Assignee: Sony Corporation, Tokyo (JP)

(21) Appl. No.: 14/595,435

(22) Filed: Jan. 13, 2015

(51) Int. Cl. G06F 3/043; G06F 3/01; G06K 9/00; G06F 1/16

(52) U.S. Cl. CPC G06F 3/043; G06F 3/0436; G06F 1/163; G06F 3/017; G06K 9/00355; G06F 2203/04104; G06F 2203/04808

(57) ABSTRACT

A method, a device, and a non-transitory storage medium having instructions to analyze a characteristic of an ultrasonic signal that propagated on a body of a user of the computational device and effected by an on-body action, performed by the user, in an area in which the ultrasonic signal has propagated; determine one or more sides of the computational device at which the on-body action is performed relative to the computational device; and select an input based on an analysis of the ultrasonic signal and the one or more sides.

### BACKGROUND

A mobile device offers various services to their users. Users may interact with the displays of the mobile devices via touch panels and/or touchless panels. While touch and touchless input technologies allow users a great deal of flexibility when operating the mobile devices, designers and manufacturers are continually striving to improve the interoperability of the mobile device with the user.

### SUMMARY

According to one aspect, a method may comprise transmitting, by a device that is worn by a user, an ultrasonic signal, wherein the ultrasonic signal propagates on the user's body; receiving, by the device, an ultrasound event that includes receipt of the ultrasonic signal that propagated on the user's body and effected by an on-body action, performed by the user on the user's body, in an area in which the ultrasonic signal has propagated; analyzing, by the device, a characteristic of the ultrasonic signal received; determining, by the device, one or more sides of the device at which the on-body action is performed relative to the device; and selecting, by the device, an input based on an analysis of the ultrasound event and the one or more sides of the device.

Additionally, the method may comprise performing, by the device, an operation specified by the input, wherein the on-body action is a multi-touch action or a multi-gesture action in which each touch or each gesture is performed on different sides of the device simultaneously, and wherein the determining may comprise determining, by the device, one side of the device that a touch of the multi-touch action or a gesture of the multi-gesture action is performed relative to the device, and determining, by the device, another side of the device that another touch of the multi-touch action or another gesture of the multi-gesture action is performed relative to the device.

Additionally, the method may comprise storing a database that maps ultrasound event data to data indicating inputs, wherein the ultrasound event data includes characteristic data of the ultrasonic signal and side data that indicates a side of the device; and comparing the characteristic data and the side data to data stored in the database; and wherein the selecting may comprise selecting the input based on the comparing.

Additionally, the determining may comprise determining the one or more sides based on the receipt of the ultrasonic signal that propagated on the user's body and effected by the on-body action, wherein the frequency of the ultrasonic signal received maps to a side of the device.

Additionally, the analyzing may comprise analyzing a frequency and an amplitude of the ultrasonic signal received; and identifying the on-body action based on the analyzing.

Additionally, the determining may comprise determining the one or more sides based on an arrival time of the ultrasonic signal received that propagated on the user's body and effected by the on-body action.

Additionally, the input may be application-specific.

According to another aspect, a device may comprise an ultrasonic transmitter, wherein the ultrasonic transmitter is configured to transmit an ultrasonic signal that can propagate on a user's body; an ultrasonic receiver, wherein the ultrasonic receiver is configured to receive an ultrasonic event that includes receipt of the ultrasonic signal that propagated on the user's body and effected by an on-body action, performed by the user, in an area in which the ultrasonic signal has propagated; a memory, wherein the memory stores software; and a processor, wherein the processor may be configured to execute the software to analyze a characteristic of the ultrasonic signal received; determine one or more sides of the device at which the on-body action is performed relative to the device; and select an input based on an analysis of the ultrasound event and the one or more sides of the device.

Additionally, the device may further comprise a communication interface, wherein the processor may be further configured to execute the software to transmit, via the communication interface, the input to another device.

Additionally, the processor may be further configured to execute the software to store a database that maps ultrasound event data to data indicating inputs, wherein the ultrasound event data includes characteristic data of the ultrasonic signal and side data that indicates a side of the device; and compare the characteristic data and the side data to data stored in the database; and wherein, when selecting, the processor may be further configured to execute the software to select the input based on a comparison.

Additionally, the processor may be further configured to execute the software to determine the one or more sides based on the receipt of the ultrasonic signal that propagated on the user's body and effected by the on-body action, wherein the frequency of the ultrasonic signal received maps to a side of the device.

Additionally, the processor may be further configured to execute the software to analyze a frequency and an amplitude of the ultrasonic signal received; and identify the on-body action based on an analysis of the frequency and the amplitude.

Additionally, the device may comprise a display, and the on-body action may be a multi-touch action or a multi-gesture action in which each touch or each gesture is performed on different sides of the device simultaneously, and the processor may be further configured to execute the software to determine one side of the device that a touch of the multi-touch action or a gesture of the multi-gesture action is performed relative to the device, and determine another side of the device that another touch of the multi-touch action or another gesture of the multi-gesture action is performed relative to the device.

Additionally, the processor may be further configured to execute the software to determine the one or more sides based on an arrival time of the ultrasonic signal that propagated on the user's body and effected by the on-body action.

Additionally, the software may comprise a machine learning module that allows the user to train the device to recognize particular on-body actions performed by the user and select inputs corresponding to the on-body actions.

According to yet another aspect, a non-transitory storage medium may store instructions executable by a processor of a computational device, which when executed, cause the computational device to analyze a characteristic of an ultrasonic signal that propagated on a body of a user of the computational device and effected by an on-body action, performed by the user, in an area in which the ultrasonic signal has propagated; determine one or more sides of the computational device at which the on-body action is performed relative to the computational device; select an input based on an analysis of the ultrasonic signal and the one or more sides; and perform an action specified by the input.

Additionally, the instructions may comprise instructions to determine the one or more sides based on a receipt of the ultrasonic signal that propagated on the body of the user and effected by the on-body action, wherein a frequency of the ultrasonic signal received maps to a side of the computational device.

Additionally, the instructions may comprise instructions to store a database that maps ultrasonic signal profiles to inputs; and use the database to select the input.

Additionally, the instructions may comprise instructions to determine the one or more sides based on an arrival time of the ultrasonic signal that propagated on the body of the user and effected by the on-body action.

Additionally, the on-body action may be a multi-touch action or a multi-gesture action.

### DESCRIPTION OF THE DRAWINGS

FIG. 1 is a diagram illustrating an exemplary environment in which exemplary embodiments of multi-on-body action detection may be implemented;

FIG. 2A is a diagram illustrating exemplary components of an ultrasound device of FIG. 1;

FIG. 2B is a diagram illustrating exemplary components of the ultrasound device of FIG. 1;

FIG. 2C is a diagram illustrating an exemplary configuration of ultrasonic transmitters and ultrasonic receivers on the ultrasound device of FIG. 1;

FIG. 2D is a diagram illustrating an exemplary database;

FIGS. 3A-3F are diagrams illustrating exemplary on-body actions pertaining to an exemplary embodiment of multi-on-body action detection;

FIG. 3G is a diagram illustrating another exemplary environment in which exemplary embodiments of multi-on-body action detection may be implemented; and

FIG. 4 is a flow diagram illustrating an exemplary process to provide a multi-on-body action detection service.

### DETAILED DESCRIPTION OF PREFERRED EMBODIMENTS

The following detailed description refers to the accompanying drawings. The same reference numbers in different drawings may identify the same or similar elements.

Ultrasound transmission and sensing through a user's body have become a recent area of research with respect to touch input. For example, the user may wear a wristlet or an armband in which ultrasonic signals are transmitted and propagated via the user's skin (e.g., transdermal ultrasound propagation). The wearable device includes a transmitter, which transmits the ultrasonic signal, and a receiver, which receives the ultrasonic signal. According to an exemplary use case, the user may touch his or her forearm with his or her finger, grip the forearm, or perform a slide movement on the forearm. The ultrasonic signal is measured at one or multiple frequencies and/or amplitudes via the receiver. Based on the received value(s) and stored signal profiles, the type of input performed by the user can be determined. For example, the user may tap his or her forearm and this information (i.e., tap) may be determined. This information can be used as an input to the wearable device or another device.

A problem with wearable devices, such as wristlet devices or armband-type devices, is that the displays included in this type of device are small. As a result, the user's interaction with such a device is somewhat prohibitive because the user's gesture on such a small display substantially, if not totally, covers the user's view of the small display. While ultrasound detection technology may allow the user's performance of a slide gesture on his or her arm to be detected, multi-on-body user actions (e.g., multi-touch slide gestures, etc.) have not been explored. For example, a multi-on-body user action may include the user using two fingers to perform two separate gestures on different areas of the user's body. The user may perform these two separate gestures (e.g., as one gesture) nearly simultaneously.

According to an exemplary embodiment, an ultrasound device permits the detection of a user's multi-on-body action that occurs on at least two different sides of or locales relative to the ultrasound device, and the subsequent use of such an input. By way of further example, the user may perform a touch and a slide gesture, using his or her thumb and index finger, placed on different sides of the ultrasound device. As described further below, the ultrasound device permits the detection of other forms of on-body actions as well, such as, single touch, single gesture, etc., which may be performed serially, etc. The term “on-body action” includes a user action performed on the user's body (e.g., arm, hand, leg, torso, head, face, neck, etc.). In this way, the term “on-body action” and “body” are to be broadly interpreted to include any area on the user. Additionally, the “on-body action” may be performed, by the user, using his or her hand (e.g., finger(s), thumb, etc.), an instrument (e.g., a stylus, a glove, etc.), etc.

According to an exemplary embodiment, the ultrasound device includes an ultrasonic transducer. The ultrasonic transducer includes a transducer that acts as a transmitter of ultrasound and another transducer that acts as a receiver of the ultrasound. The ultrasound device may also include a multiplexer. The multiplexer splits signals transmitted from the transmitter and signals received by the receiver. For example, ultrasonic signals may be intermittently transmitted and intermittently received based on time division multiplexing. Alternatively, the multiplexer may use frequency-division multiplexing or some combination of time and frequency-division multiplexing. According to an exemplary embodiment, the ultrasound device may include a single transmitter and a single receiver. Alternatively, the ultrasound device may include multiple ultrasonic transmitters and ultrasonic receivers.

According to an exemplary embodiment, each transmitter can transmit ultrasonic signals at different frequencies. For example, the ultrasonic transducer may be able to transmit an ultrasonic signal at a frequency ranging between 30 kHz through 60 kHz, or other suitable frequency range (e.g. between 20 kHz and 100 kHz or any range within this range). According to an exemplary embodiment, each receiver can receive ultrasonic signals at different frequencies. For example, the ultrasonic transducer may be able to receive an ultrasonic signal at frequency ranging between 30 kHz through 60 kHz, or other suitable frequency range (e.g. between 20 kHz and 100 kHz or any range within this range). The transmitter and the receiver may change, over time, the frequency at which an ultrasonic signal is transmitted and received. Alternatively, multiple transmitters and receivers may be used in which each operate at a distinct, but different frequency or set of frequencies.

When multiple transmitters are used that operate at different frequencies, the frequency of a received ultrasonic signal, by an ultrasonic receiver, may be used as a basis for identifying on which side of or locale relative to the ultrasound device the user's on-body action is performed, in view of the location of the transmitter and the frequency at which the transmitter operates. Additionally, or alternatively, since the distance from the user's on-body action to multiple receivers may be of a different length, this difference may be used to identify on which side of or locale relative to the ultrasound device the user's on-body action is performed. For example, the arrival time of an ultrasonic signal, as received by the ultrasonic receiver, may be used to determine on which side of or locale relative to the ultrasound device the user's on-body action is performed.

During the time that the ultrasonic transducers transmit the ultrasonic signal, the user performs an on-body action. For example, with respect to a user's multi-on-body action, the user may use his or her hand, such as, for example, using multiple fingers or a finger and a thumb placed on the user's body and located on different sides of or locales relative to the ultrasound device. The ultrasound device identifies the multi-on-body action based on values of the signals received via the ultrasonic receiver. The ultrasound device maps the identified multi-on-body action to an input, and in turn, performs the input.

According to an exemplary embodiment, the ultrasound device constitutes a main device. For example, the ultrasound device may include a display and provides a service or includes an application. For example, the ultrasound device may play audio and/or visual content (e.g., music, movies, etc.), provide a communication service (e.g., telephone, texting), a web access service, and/or a geo-location service, etc. According to another embodiment, a main device receives input from the ultrasound device. For example, the main device may take the form of a mobile device, a television, or any other end user device. As inputs are interpreted based on ultrasonic signals and user actions, these inputs are transmitted by the ultrasound device to the main device. The main device operates according to the received inputs.

According to an exemplary embodiment, the ultrasound device is a wearable device. For example, the ultrasound device may be implemented as a wristlet device, or an armband device. Other on-body-area-based devices (e.g., a neck device, a leg device, a head-worn device, such as a visor or glasses, etc.) may also be implemented. However, such devices may or may not include a display and/or operate as a main device.

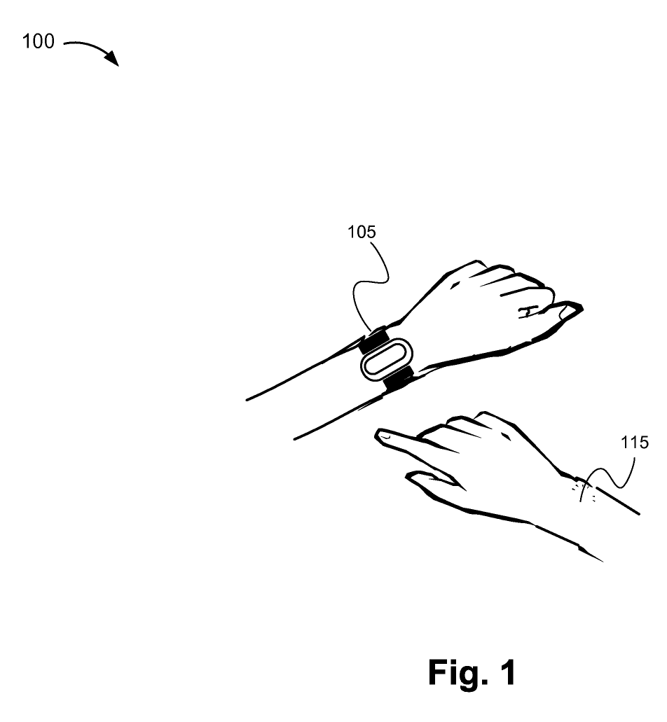

FIG. 1 is a diagram of an exemplary environment 100 in which exemplary embodiments of an ultrasound device that provides multi-on-body action detection may be implemented. As illustrated, environment 100 includes an ultrasound device 105 and a user 115.

Although FIG. 1 illustrates ultrasound device 105 as a wristlet-type device, according to other embodiments, other forms of wearable ultrasound devices may be implemented, as previously described.

Referring to FIG. 1, ultrasound device 105 includes a device that transmits and receives ultrasonic signals. For example, ultrasound device 105 includes an ultrasonic transducer. The ultrasonic transducer includes a transmitter of ultrasonic signals. According to an exemplary embodiment, the transmitter can transmit ultrasonic signals at different frequencies. Additionally, for example, ultrasound device 105 includes another ultrasonic transducer. The other ultrasonic transducer includes a receiver of ultrasonic signals. According to an exemplary embodiment, the receiver can receive ultrasonic signals at different frequencies. Ultrasound device 105 may include a single transmitter or multiple transmitters. Additionally, or alternatively, ultrasound device 105 may include a single receiver or multiple receivers.

Ultrasound device 105 includes a display. According to this exemplary embodiment, ultrasound device 105 is a main device. For example, ultrasound device 105 may present to the user, via the display, user interfaces to operate or control ultrasound device 105 and/or user interfaces associated with various applications (e.g., a media player, a telephone, etc.), services, etc.

According to an exemplary embodiment, ultrasound device 105 is configured to receive and interpret single touch, multi-touch, single gesture, multi-gesture, single-touch and gesture, multi-touch and multi-gesture, etc., type of inputs performed by a user. According to an exemplary embodiment, ultrasound device 105 is configured to receive and interpret various types of inputs that are performed on different sides of or locales relative to ultrasound device 105. User 115 may use his or her hand to perform various actions (e.g., tap, sliding gesture, palm, etc.), which in turn are interpreted as an input.

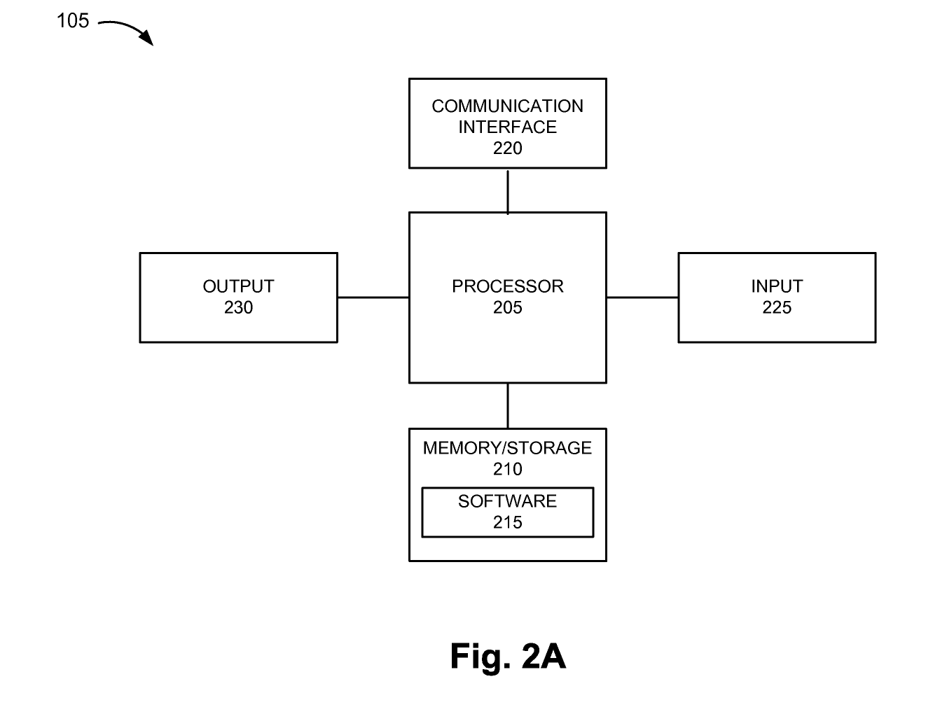

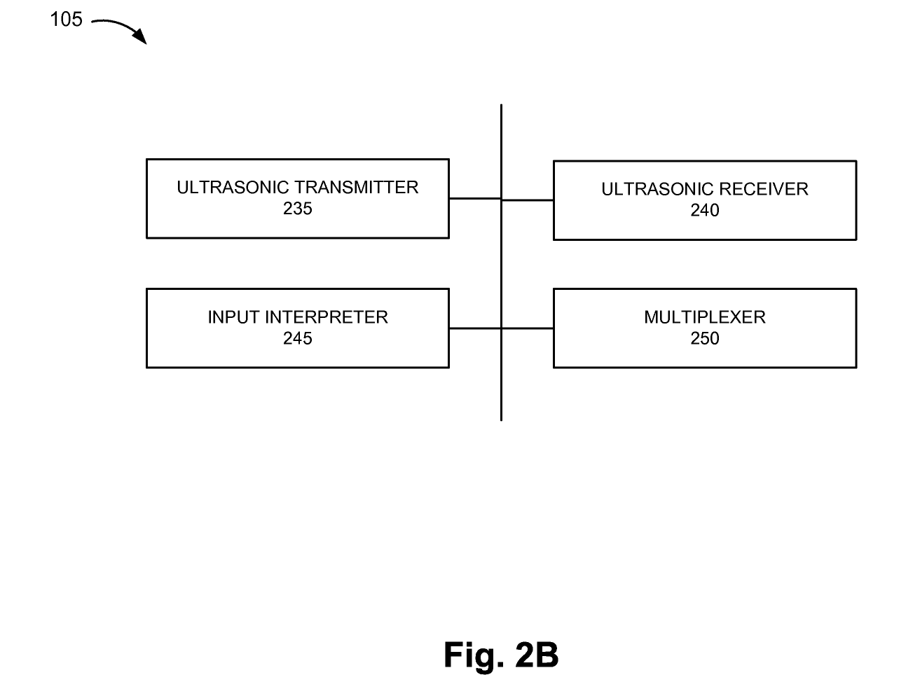

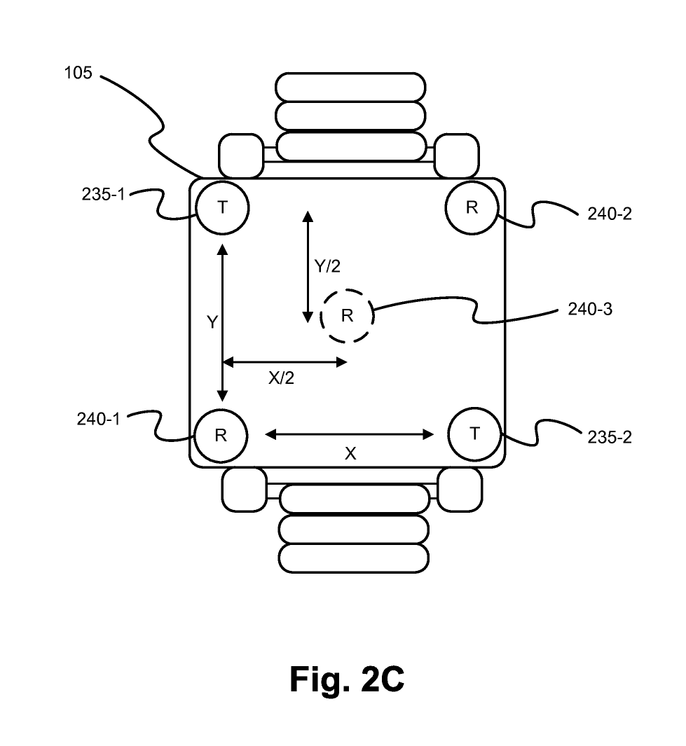

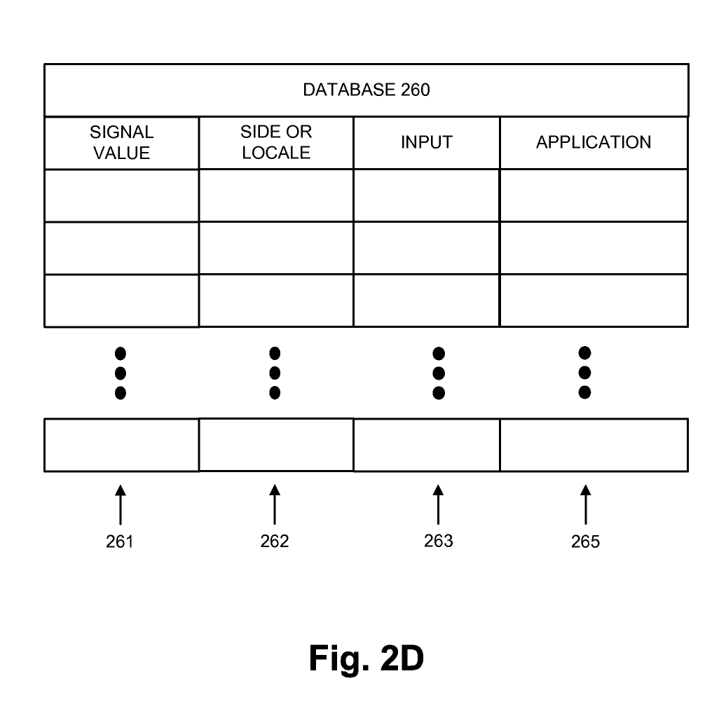

FIG. 2A is a diagram illustrating exemplary components of ultrasound device 105. As illustrated, according to an exemplary embodiment, ultrasound device 105 includes a processor 205, memory/storage 210, software 215, a communication interface 220, an input 225, and an output 230. According to other embodiments, ultrasound device 105 may include fewer components, additional components, different components, and/or a different arrangement of components than those illustrated in FIG. 2A and described herein.

Processor 205 includes one or multiple processors, microprocessors, data processors, co-processors, and/or some other type of component that interprets and/or executes instructions and/or data. Processor 205 may be implemented as hardware (e.g., a microprocessor, etc.) or a combination of hardware and software (e.g., a system-on-chip (SoC), an application-specific integrated circuit (ASIC), etc.). Processor 205 performs one or multiple operations based on an operating system and/or various applications or programs (e.g., software 215).

Memory/storage 210 includes one or multiple memories and/or one or multiple other types of storage mediums. For example, memory/storage 210 may include random access memory (RAM), dynamic random access memory (DRAM), cache, read only memory (ROM), a programmable read only memory (PROM), and/or some other type of memory. Memory/storage 210 may include a hard disk (e.g., a magnetic disk, an optical disk, a magneto-optic disk, a solid state disk, etc.).

Software 215 includes an application or a program that provides a function and/or a process. Software 215 may include firmware. By way of example, software 215 may comprise a telephone application, a multi-media application, an e-mail application, a contacts application, a calendar application, an instant messaging application, a web browsing application, a location-based application (e.g., a Global Positioning System (GPS)-based application, etc.), a camera application, etc. Software 215 includes an operating system (OS). For example, depending on the implementation of ultrasound device 105, the operating system may correspond to iOS, Android, Windows Phone, Symbian, or another type of operating system (e.g., proprietary, BlackBerry OS, etc.). According to an exemplary embodiment, software 215 includes an application that, when executed, provides multi-on-body action detection, as described herein.

Communication interface 220 permits ultrasound device 105 to communicate with other devices, networks, systems, etc. Communication interface 220 may include one or multiple wireless interfaces and/or wired interfaces. Communication interface 220 may include one or multiple transmitters, receivers, and/or transceivers. Communication interface 220 operates according to one or multiple protocols, a communication standard, and/or the like. Communication interface 220 permits communication with ultrasound device 105.

Input 225 permits an input into ultrasound device 105. For example, input 225 may include a button, a switch, a touch pad, an input port, speech recognition logic, a display (e.g., a touch display, a touchless display), and/or some other type of input component (e.g., on-body action detection). Output 230 permits an output from ultrasound device 105. For example, output 230 may include a speaker, a display, a light, an output port, and/or some other type of output component.

Ultrasound device 105 may perform a process and/or a function in response to processor 205 executing software 215 stored by memory/storage 210. By way of example, instructions may be read into memory/storage 210 from another memory/storage 210 or read into memory/storage 210 from another device via communication interface 220. The instructions stored by memory/storage 210 causes processor 205 to perform the process or the function. Alternatively, ultrasound device 105 may perform a process or a function based on the operation of hardware (processor 205, etc.).

FIG. 2B is a diagram illustrating exemplary components of ultrasound device 105. As illustrated, according to an exemplary embodiment, ultrasound device 105 includes an ultrasonic transmitter 235, an ultrasonic receiver 240, an input interpreter 245, and a multiplexer 250. According to other embodiments, ultrasound device 105 may include additional components, different components, and/or a different arrangement of components than those illustrated in FIG. 2B and described herein. The connections between the components are exemplary.

Ultrasonic transmitter 235 transmits an ultrasonic signal. For example, ultrasonic transmitter 235 transmits ultrasonic signals between 20 kHz and 100 kHz or any sub-range within the range of 20 kHz and 100 kHz. Ultrasonic transmitter 235 may be configured to transmit at a particular center frequency. Ultrasonic transmitter 235 may be implemented using an ultrasonic transducer, an ultrasonic sensor, or an audio signal generator. For example, a low-cost piezoelectric ultrasonic transducer may be used.

Ultrasonic receiver 240 receives an ultrasonic signal. For example, ultrasonic receiver 240 receives ultrasonic signals between 20 kHz and 100 kHz or any sub-range within the range of 20 kHz and 100 kHz. Ultrasonic receiver 240 measures a characteristic of the ultrasonic signal, such as frequency, amplitude, and/or phase. Ultrasonic receiver 240 may be implemented using an ultrasonic transducer, an ultrasonic sensor, or other audio codec chip.

Referring to FIG. 2C, according to an exemplary embodiment, multiple ultrasonic transmitters 235 and multiple ultrasonic receivers 240 are integrally included and situated with ultrasound device 105. For example, ultrasound device 105 may include ultrasonic transmitters 235-1 through 235-2 (also referred to as ultrasonic transmitters 235) and ultrasonic receivers 240-1 through 240-2 (also referred to as ultrasonic receivers 240). According to other embodiments, ultrasound device 105 may include additional or fewer ultrasonic transmitters 235 and/or ultrasonic receivers 240. Additionally, or alternatively, these components may be situated in locations different from those illustrated. Additionally, or alternatively, ultrasonic transmitters 235 and ultrasonic receivers 240 may be implemented as a single component (e.g., an ultrasonic transceiver).

According to an exemplary implementation, ultrasonic transmitters 235 and ultrasonic receivers 240 are situated on a bottom-side of ultrasound device 105 so that ultrasonic transmitters 235 and ultrasonic receivers 240 have contact with the user's skin (i e, user contact). For example, ultrasonic transmitters 235 and ultrasonic receivers 240 may be housed within a conductive material (e.g., copper, etc.). By way of further example, conductive pads may be used to make contact with the user and provide a pathway to and from the user for the transmission and receipt of ultrasonic signals.

According to an exemplary implementation, ultrasonic transmitters 235 and ultrasonic receivers 240 are situated close to the edges of the bottom-side of ultrasound device 105. According to an exemplary implementation, there is a known distance between ultrasonic transmitters 235 and ultrasonic receivers 240 to provide a basis for detecting on which side of or locale relative to ultrasound device 105, the user's on-body action is performed. For example, as illustrated in FIG. 2C, transmitter 235-1 is separated by a distance Y from receiver 240-1, and transmitter 235-2 is separated by a distance X from receiver 240-1. Understandably, the distances between ultrasonic transmitters 235 and ultrasonic receivers 240 may be dictated by the dimensions of ultrasonic device 105.

In view of the configuration illustrated in FIG. 2C, the distance from the user's on-body action (e.g., the user's finger touching his or her arm) to each ultrasonic receiver 240 will be different. Based on the differences in distance, this information may be used to determine which side of ultrasound device 105 the user's on-body action is performed. For example, the ultrasonic signal will be received at different times by each ultrasonic receiver 240 due to the differences in distance from the location at which the user's on-body action is performed and the location of ultrasonic receiver 240. To increase accuracy (e.g., in terms of identifying the user's on-body action and/or the side of ultrasound device 105 at which the user's on-body action is performed), an additional (optional) ultrasonic receiver 240-3 is situated in the middle area of ultrasound device 105. For example, referring to FIG. 2C, an ultrasonic signal first received by ultrasonic receiver 240-2 may be subsequently received by ultrasonic receiver 240-3 within a certain time lag period due to the additional distance (e.g., X/2 or thereabout) of which the ultrasound signal would travel to reach ultrasound receiver 240-3. This order of receipt of the ultrasound signal provides a basis to confirm that the on-body action was performed on the right-side of ultrasound device 105.

As previously described, each of ultrasonic transmitters 235 and each of ultrasonic receivers 240 may operate at different frequencies. For example, ultrasonic transmitter 235-1 may transmit an ultrasonic signal at 31 kHz and ultrasonic transmitter 235-2 may transmit an ultrasonic signal at 55 kHz. Based on the frequency differences, ultrasound device 105 may use this information to determine which side of ultrasound device 105 the user's on-body action is performed. That is, the frequency of the ultrasonic signal may map or correlate to a particular side of ultrasound device 105.

Referring back to FIG. 2B, input interpreter 245 includes logic to determine a characteristic of an ultrasonic signal received by ultrasonic receiver 240. For example, the characteristic may be the frequency of the ultrasonic signal, the amplitude of the ultrasonic signal, and/or the phase of the ultrasonic signal. An ultrasonic signal characteristic may remain static or change over time.

Input interpreter 245 may compare an ultrasonic signal characteristic included in the ultrasonic signal received by ultrasonic receiver 240 to an ultrasonic signal characteristic included in the ultrasonic signal transmitted by ultrasonic transmitter 235 so as to identify any differences between them. Based on the determined ultrasonic characteristic(s), input interpreter 245 may generate an ultrasonic signal profile or ultrasonic signal signature. The ultrasonic signal profile correlates to a particular user action (e.g., the user's gesture on the user's arm, etc.). For example, input interpreter 245 uses the ultrasonic signal profile as a basis to select a particular input. As described further below, according to an exemplary implementation, input interpreter 245 compares the ultrasonic signal profile to a database that stores ultrasonic signal profiles.

According to an exemplary embodiment, input interpreter 245 includes a pre-existing training set of sample values. For example, the sample values may be based on a sample space of various users, who may have differing muscle mass, body mass index (BMI), age, height, and/or other physical characteristics. The algorithm determines the particular input based on the generated ultrasonic signal profile and the sample values. In this way, ultrasound device 105 may be pre-trained for a user (e.g., user 115) and ready to use “out of the box.” According to another exemplary embodiment, input interpreter 245 includes a machine learning algorithm that can be trained, on a per-user basis, to calibrate, identify, and map received ultrasonic signals to particular inputs. According to such an embodiment, the user may completely train ultrasound device 105 or partially train ultrasound device 105 (e.g., tweak performance of a pre-trained, ultrasound device 105).

Input interpreter 245 includes logic to determine a side of or a locale relative to ultrasound device 105 at which the user's on-body action is performed. For example, when multiple ultrasonic receivers 240 are used, input interpreter 245 may compare ultrasonic signals received via different ultrasonic receivers 240 to determine different arrival times. Input interpreter 245 may analyze and compare ultrasonic signatures of ultrasonic signals that arrived at different times to identify similar signatures that may only differ in their arrival time, or differ in their arrival time with minor signature differences (e.g., amplitude, etc.). As previously described, based on the different arrival times, input interpreter 245 determines the side of or the locale relative to ultrasound device 105 at which the user's on-body action is performed.

Additionally, or alternatively, for example, input interpreter 245 determines the side of or the locale relative to ultrasound device 105 at which the user's on-body action is performed based on the ultrasonic frequency of the received ultrasonic signal. For example, referring to FIG. 2C, ultrasonic transmitter 235-1 transmits an ultrasonic signal at 35 kHz and ultrasonic receiver 240-1 receives the ultrasonic signal having a frequency of 35 kHz, whereas ultrasonic transmitter 235-2 transmits an ultrasonic signal having a frequency of 72 kHz and ultrasonic receiver 240-2 receives the ultrasonic signal having the frequency of 72 kHz. In this way, the side of or the locale relative to ultrasound device 105 at which the user's on-body action is performed can be identified even though the ultrasonic signal having the frequency of 35 kHz may also be received by ultrasonic receiver 240-2, and the ultrasonic signal having the frequency of 72 kHz may be received by ultrasonic receiver 240-1.

According to an exemplary embodiment, ultrasonic transmitter 235 and ultrasonic receiver 240 pairs may be configured to transmit at and receive a particular frequency or within a frequency range. For example, ultrasonic receiver 240-1 may be configured such that it is unable to receive and/or process the ultrasonic signal having the frequency of 72 kHz. Additionally, or alternatively, a filter may be used to discard an ultrasonic signal having a particular frequency or within a particular frequency range.

As previously described, input interpreter 245 may store and use a database to map received ultrasonic signals values to inputs. The database may store pre-trained and/or user-trained data that maps ultrasonic signal values to inputs. An exemplary database is described below.

FIG. 2D is a diagram illustrating an exemplary database 260. As illustrated, database 260 includes a signal value field 261, a side or locale field 262, an input field 263, and an application field 265. Depending on whether the user of ultrasound device 105 undergoes a training process (versus ultrasound device 105 that has been pre-trained), the data stored in database 260 may correspond to actual values obtained through the use of ultrasound device 105 and actions performed by the user, instead of data obtained from other users, etc. In some implementations or configurations, ultrasound device 105 may use pre-trained values and allow the user to train ultrasound device 105 (e.g., to add a mapping of an input or tweak performance of an existing mapping of an input).

Signal value field 261 stores data that indicates a characteristic of ultrasonic signals received via ultrasonic receiver 240. For example, signal value field 261 stores data indicating a signature or profile of ultrasonic signals. The signatures or the profiles may indicate frequency, amplitude, phase, and/or duration of ultrasonic signals. Signal value field 261 may also indicate user action data. For example, the user action data indicates characteristics of the action performed by the user, such as the type of action (e.g., tap, gesture, slide, multi-touch, multi-gesture, etc.), the pressure associated with the action, onset of the action, offset of the action, etc.

Side or locale field 262 stores data that indicates a side of or a locale relative to ultrasound device 105 pertaining to the on-body action performed by the user. For example, the data may indicate a left-side, a right-side, a top-side, a bottom-side pertaining to a received ultrasonic signal and ultrasound device 105. For example, the data may indicate that the ultrasonic signal is received at a left-side of ultrasound device 105. Alternatively, other types of side or locale data may be implemented, such as direction. For example, the data may indicate that an ultrasonic signal is received from a particular direction (e.g., a compass direction, in terms of degrees (e.g., 270 degrees), etc.).

Input field 263 stores data indicating an input. The input can be used to control the operation of ultrasound device 105. Given the wide variety of inputs available, the input may correspond to a mouse input (e.g., a single click, a double click, a left button click, a right button click, etc.), a keyboard input (e.g., enter, delete, escape, etc.), a gesture on a touch display (e.g., tap, drag, twist, rotate, scroll, zoom, etc.), etc. The input may be application-specific or global. For example, an application-specific input may be an input that changes the volume of a media player. According to another example, a global input may be a mouse click or an enter command which may apply to various applications of ultrasound device 105. In this way, the input may be used to control ultrasound device 105, such as interact, navigate, use, etc., a user interface via various user inputs, such as, select, pan, zoom-in, zoom-out, rotate, navigate through a menu, control the amount of menu items displayed, pinch-in, pinch-out, etc.

Application field 265 stores data indicating an application to which the input pertains. For example, an input may be to control the volume of a ring tone of a telephone application or the volume of a media player application.

Referring back to FIG. 2B, multiplexer 250 provides for the multiplexing of ultrasonic signals. For example, multiplexer 250 multiplexes transmitted ultrasonic signals (e.g., from ultrasonic transmitter 235) and received ultrasonic signals (e.g., from ultrasonic receiver 240). According to an exemplary implementation, multiplexer 250 provides time-division multiplexing. According to another exemplary implementation, multiplexer 250 provides frequency-division multiplexing.

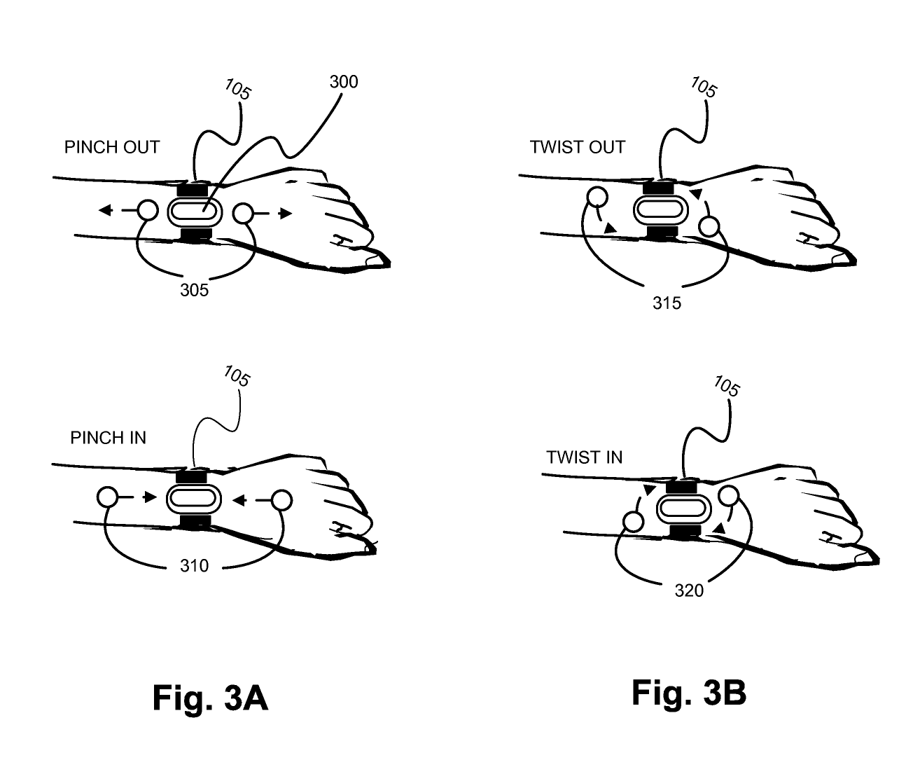

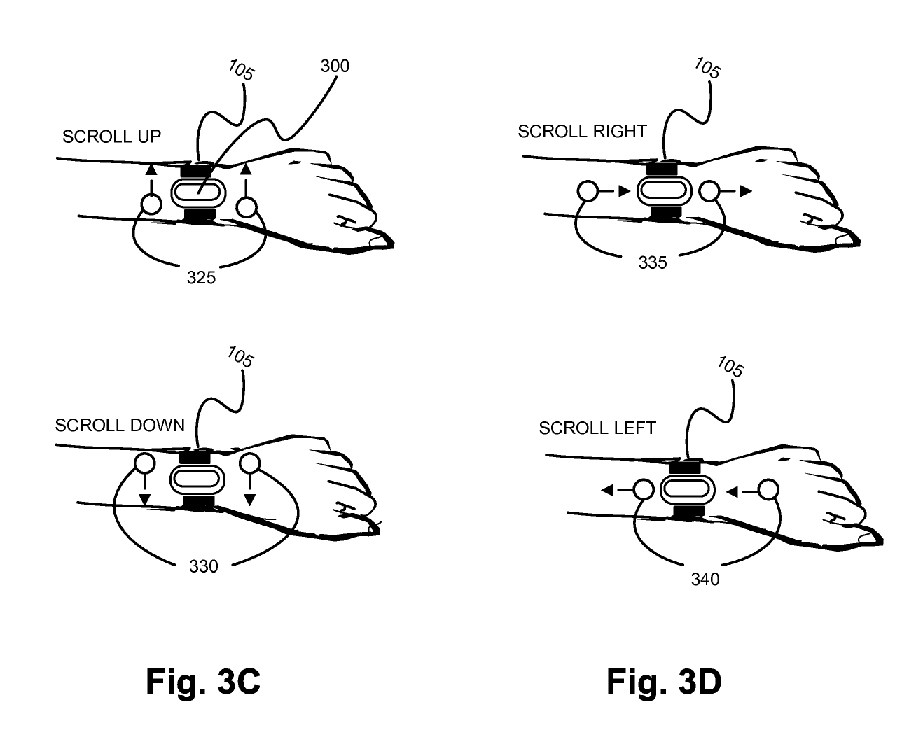

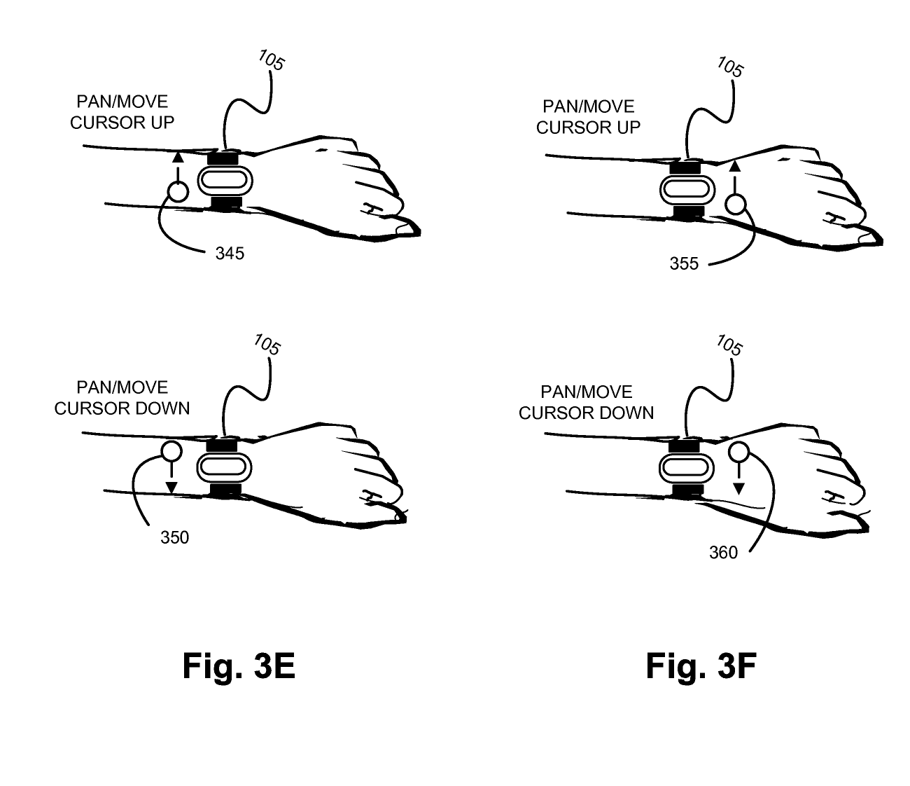

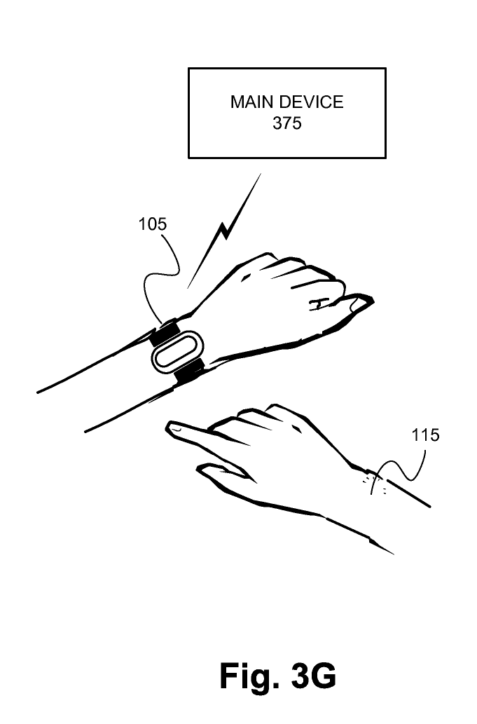

FIGS. 3A-3D are diagrams illustrating exemplary on-body actions performed by user 115. As illustrated, user 115 may perform various multi-on-body user actions (e.g., multi-touch, multi-touch and slide gesture, etc.) on his or her forearm and left hand while wearing ultrasound device 105. As illustrated, the multi-on-body user actions are performed on two sides of or locales relative to ultrasound device 105. For example, user 115 may use his or her right hand (e.g., thumb and index finger, index finger and pinky (also known as baby) finger, etc.) to perform the illustrated on-body actions. The inputs described in relation to FIGS. 3A-3D, which are mapped to the exemplary multi-on-body user actions, are also exemplary. Additionally, user 115 may perform these exemplary on-body actions without blocking or minimally blocking his or her view of a display portion 300 of ultrasound device 105.

Referring to FIG. 3A, user 115 uses his or her right hand (not illustrated) to perform a multi-touch and slide gesture 305 (e.g., a pinch out). In response, ultrasound device 105 performs a zoom out operation. Referring to FIG. 3A, user 115 uses his or her right hand to perform a multi-touch and slide gesture 310 (e.g., a pinch in). In response, ultrasound device 105 performs a zoom in operation.

Referring to FIG. 3B, user 115 uses his or her right hand to perform a multi-touch and slide gesture 315 (e.g., a twist out). In response, ultrasound device 105 performs a right rotation operation. Referring to FIG. 3B, user 115 uses his or her right hand to perform a multi-touch and slide gesture 320 (e.g., a twist in). In response, ultrasound device 105 performs a left rotation operation.

Referring to FIG. 3C, user 115 uses his or her right hand to perform a multi-touch and slide gesture 325 (e.g., a scroll up). In response, ultrasound device 105 performs an upward scroll operation. Referring to FIG. 3C, user 115 uses his or her right hand to perform a multi-touch and slide gesture 330 (e.g., a scroll down). In response, ultrasound device 105 performs a downward scroll operation.

Referring to FIG. 3D, user 115 uses his or her right hand to perform a multi-touch and slide gesture 335 (e.g., a scroll right). In response, ultrasound device 105 performs a rightward scroll operation. Referring to FIG. 3D, user 115 uses his or her right hand to perform a multi-touch and slide gesture 340 (e.g., a scroll left). In response, ultrasound device 105 performs a leftward scroll operation.

FIGS. 3E and 3F are diagrams illustrating exemplary on-body actions performed by user 115. As illustrated, user 115 may perform various single-on-body user actions (e.g., touch and slide gesture, etc.) on his or her forearm or left hand while wearing ultrasound device 105. As illustrated, the single-on-body user actions are performed on either side of or different locales relative to ultrasound device 105. For example, user 115 may use his or her right hand (e.g., index finger) to perform the illustrated on-body actions. The inputs described in relation to FIGS. 3E and 3F, which are mapped to the exemplary on-body user actions, are also exemplary.

Referring to FIG. 3E, user 115 uses his or her right hand to perform a single-touch and slide gesture 325 (e.g., a pan/move cursor up on a left side of ultrasound device 105). In response, ultrasound device 105 performs an upward operation. Referring to FIG. 3E, user 115 uses his or her right hand to perform a single-touch and slide gesture 350 (e.g., a pan/move cursor down on a left side of ultrasound device 105). In response, ultrasound device 105 performs a downward operation.

Referring to FIG. 3F, user 115 uses his or her right hand to perform a single-touch and slide gesture 355 (e.g., a pan/move cursor up on a right side of ultrasound device 105). In response, ultrasound device 105 performs an upward operation. Referring to FIG. 3F, user 115 uses his or her right hand to perform a multi-touch and slide gesture 360 (e.g., a pan/move cursor down on a right side of ultrasound device 105). In response, ultrasound device 105 performs a downward operation.

While FIGS. 3E and 3F illustrate single-touch and slide gestures performed on different sides of or locales relative to ultrasound device 105, which result in identical operations being performed by ultrasound device 105. According to other embodiments, the side or locale data may be used to allow the same on-body action performed on different sides of or locales relative to ultrasound device 105 to result in different operations being performed. For example, single-touch and slide gesture 345 may be mapped to an upward scroll operation while single-touch and slide gesture 355 may be mapped to a page up operation. Alternatively, on-body actions performed on left and right sides may be mapped to left and right mouse button movements. In this way, the side at which the user performs an on-body action relative to ultrasound device 105 may provide an expansive array of available mappings.

FIG. 3G is a diagram illustrating another exemplary environment in which exemplary embodiments of multi-on-body action detection may be implemented. For example, as previously described, ultrasound device 105 may not constitute the main device or ultrasound device 105 may be used in conjunction with another device. For example, referring to FIG. 3G, ultrasound device 105 may wirelessly communicate to a main device 375. For example, main device 375 may be implemented as a display device (e.g., a television), a mobile device (e.g., a smart phone, a tablet, etc.), or any other type of end user device. In a manner similar to that previously described, when user 115 performs an on-body action, ultrasound device 105 may determine an input. Ultrasound device 105 may also transmit, via communication interface 220, an input signal to main device 375. Main device 375 receives the input signal and performs the appropriate operation. Additionally, or alternatively, ultrasound device 105 may use main device 375 as a larger display device.

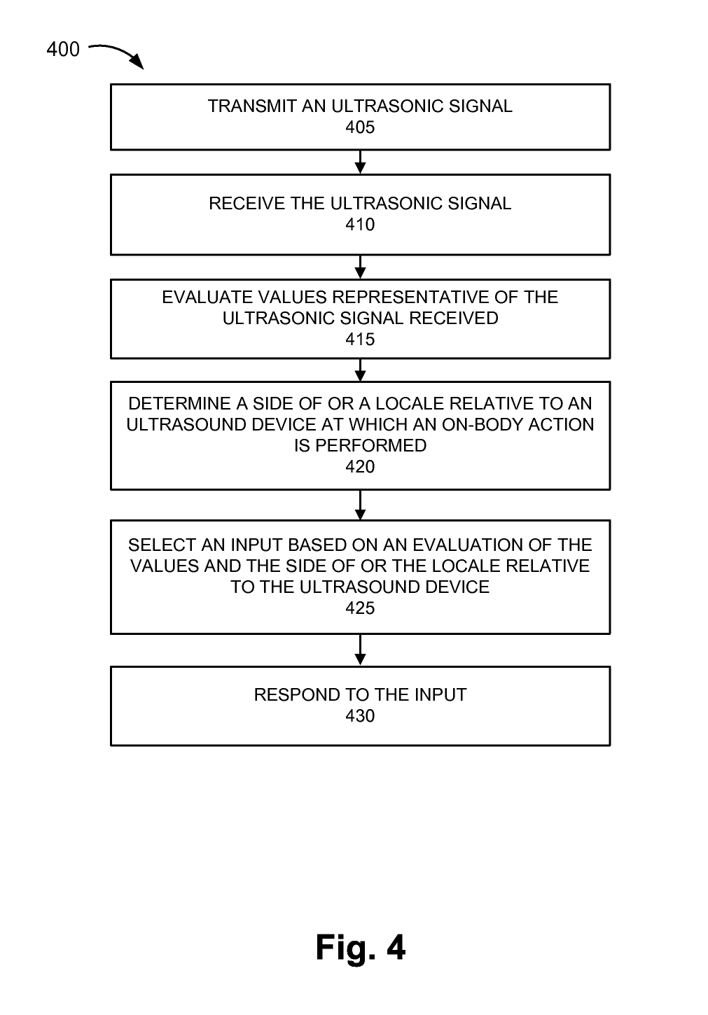

FIG. 4 is a flow diagram illustrating an exemplary process 400 to provide multi-on-body action detection. A step or an act described in process 400 may be performed by one or multiple components of ultrasound device 105. For example, processor 205 may execute software 215 to perform the step described. According to process 400, assume that ultrasound device 105 has been trained and able to select an input based on receiving ultrasound events.

Referring to FIG. 4, in block 405, an ultrasonic signal is transmitted. For example, ultrasonic transmitter 235 transmits an ultrasonic signal. The ultrasonic signal propagates along one or multiple portions of a user's body. Assume that the user performs some action on a portion of the user's body via which the ultrasonic signal propagates. By way of example, the user may perform a multi-touch gesture, simultaneously, on different sides of ultrasound device 105.

In block 410, the ultrasonic signal is received. For example, ultrasonic receiver 240 of ultrasound device 105 receives the ultrasonic signal. Ultrasonic receiver 240 passes values representative of the received ultrasonic signal to input interpreter 245. As previously described, multiplexer 250 may provide a multiplexing service in relation to the transmitted and received ultrasonic signals.

In block 415, the ultrasonic signal is evaluated. For example, input interpreter 245 evaluates the values to select a particular input. For example, input interpreter 245 uses database 260 to compare ultrasonic signal characteristics associated with the ultrasonic signal with the data stored in database 260.

In block 420, a side of or a locale relative to an ultrasound device at which an on-body action is performed, is determined. For example, input interpreter 245 may use frequency of the ultrasonic signal received and/or arrival time to determine the side of or the locale relative to ultrasound device 105 at which the multi-on-body action is performed by the user.

In block 425, an input is selected based on an evaluation of the values and the side of or the locale relative to the ultrasound device. For example, input interpreter 245 uses the ultrasonic signal characteristic(s) and the side or locale data to select the appropriate input. For example, input interpreter 245 uses database 260 to select the input mapped to the values and the side or locale data stored in database 260 that matched or best matched the values associated with the received ultrasonic signal and the side or locale data. Input interpreter 245 may discern between a single-side on-body action and a multi-sided on-body action.

In block 430, the ultrasound device responds to the input. For example, ultrasound device 105 executes processes associated with the input.

Although FIG. 4 illustrates an exemplary process 400 to provide multi-on-body action detection, process 400 may include additional operations, fewer operations, and/or different operations than those illustrated in FIG. 4, and as described.

The foregoing description of embodiments provides illustration, but is not intended to be exhaustive or to limit the embodiments to the precise form disclosed. Accordingly, modifications to the embodiments described herein may be possible. For example, ultrasound device 105 may include a gyroscope. The gyroscope may provide orientation data. In this way, in addition to side or locale data, orientation may add another dimension to the available inputs. For example, ultrasound device 105 may detect that the user's arm is oriented downward or upward. Based on this additional data, different types of inputs may be mapped to the user's on-body actions.

Ultrasound propagation through muscle tissue travels at different speeds depending on how taut one's muscle is made. For example, the velocity of ultrasound propagation may be increased (e.g., up to 3 m/s) when a muscle is contracted due to the blood content of the muscle. Based on this phenomenon, a modal interface based on ultrasound sensing is provided. For example, ultrasound device 105 detects different modes of interface based on whether the user's muscle is contracted or not. For example, one mode of operation is when the user's muscle is in a relaxed state and another mode of operation is when the user's muscle is in a contracted or a taut state. In this way, the array of available inputs, which may be mapped to on-body actions based on the mode of interface, may be further expanded.

According to an exemplary implementation, the arrival time of the ultrasonic signal may indicate whether the user's muscle (e.g., arm, etc.) is in a contracted state or not. Input interpreter 245 may determine differences in propagation speed based on a time the ultrasound signal was transmitted by an ultrasonic transmitter and the time the ultrasonic signal is received by an ultrasonic receiver. Database 260 may also store signature profiles and/or state of muscle data pertaining to when the user or a set of other users (e.g., when ultrasound device 105 is pre-trained) performed on-body actions when muscles were in a contracted and a relaxed state. Input interpreter 245 may select an input in a manner similar to that previously described.

Although, according to an exemplary embodiment, ultrasound device 105 includes a display. According to other embodiments, ultrasound device 105 may not include a display. Additionally, or alternatively, according to an exemplary embodiment, ultrasound device 105 may not include a communication interface that allows ultrasound device 105 to communicate with, for example, another device and/or a network.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while a series of blocks has been described with regard to the process illustrated in FIG. 4, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software, firmware, and/or hardware. For example, a process or a function may be implemented as “logic” or as a “component.” This logic or this component may include hardware (e.g., processor 205, a dedicated processor (not illustrated), etc.) or a combination of hardware and software (e.g., software 215). The embodiments have been described without reference to the specific software code since software can be designed to implement the embodiments based on the description herein and the accompanying drawings.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 210.

The terms “comprise,” “comprises” or “comprising,” as well as synonyms thereof (e.g., include, etc.), when used in the specification is meant to specify the presence of stated features, integers, steps, or components but does not preclude the presence or addition of one or more other features, integers, steps, components, or groups thereof. In other words, these terms are to be interpreted as inclusion without limitation.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the present application should be construed as critical or essential to the embodiments described herein unless explicitly described as such.

What is claimed is:

1. A method comprising:
transmitting, by a device that is worn by a user, an ultrasonic signal, wherein the ultrasonic signal propagates on the user's body;
receiving, by the device, an ultrasound event that includes receipt of the ultrasonic signal that propagated on the user's body and effected by an on-body action, performed by the user on the user's body, in an area in which the ultrasonic signal has propagated;
analyzing, by the device, a characteristic of the ultrasonic signal received;
determining, by the device, one or more sides of the device at which the on-body action is performed relative to the device; and
selecting, by the device, an input based on an analysis of the ultrasound event and the one or more sides of the device.

2. The method of claim 1, further comprising:
performing, by the device, an operation specified by the input, wherein the on-body action is a multi-touch action or a multi-gesture action in which each touch or each gesture is performed on different sides of the device simultaneously, and wherein the determining comprises:
determining, by the device, one side of the device that a touch of the multi-touch action or a gesture of the multi-gesture action is performed relative to the device; and
determining, by the device, another side of the device that another touch of the multi-touch action or another gesture of the multi-gesture action is performed relative to the device.

3. The method of claim 1, further comprising:
storing a database that maps ultrasound event data to data indicating inputs, wherein the ultrasound event data includes characteristic data of the ultrasonic signal and side data that indicates a side of the device; and
comparing the characteristic data and the side data to data stored in the database; and wherein the selecting comprises:
selecting the input based on the comparing.

4. The method of claim 1, wherein determining the one or more sides is based on the receipt of the ultrasonic signal that propagated on the user's body and effected by the on-body action, wherein a frequency of the ultrasonic signal received maps to a side of the device.

5. The method of claim 1, wherein the analyzing comprises:
analyzing a frequency and an amplitude of the ultrasonic signal received; and
identifying the on-body action based on the analyzing.

6. The method of claim 1, wherein determining the one or more sides is based on an arrival time of the ultrasonic signal received that propagated on the user's body and effected by the on-body action.

7. The method of claim 1, wherein the input is application-specific.

8. A device comprising:
an ultrasonic transmitter, wherein the ultrasonic transmitter is configured to transmit an ultrasonic signal that can propagate on a user's body;
an ultrasonic receiver, wherein the ultrasonic receiver is configured to receive an ultrasonic event that includes receipt of the ultrasonic signal that propagated on the user's body and effected by an on-body action, performed by the user, in an area in which the ultrasonic signal has propagated;
a memory, wherein the memory stores software; and
a processor, wherein the processor is configured to execute the software to:
analyze a characteristic of the ultrasonic signal received;
determine one or more sides of the device at which the on-body action is performed relative to the device; and
select an input based on an analysis of the ultrasonic event and the one or more sides of the device.

9. The device of claim 8, further comprising:
a communication interface, wherein the processor is further configured to execute the software to:
transmit, via the communication interface, the input to another device.

10. The device of claim 8, wherein the processor is further configured to execute the software to:
store a database that maps ultrasound event data to data indicating inputs, wherein the ultrasound event data includes characteristic data of the ultrasonic signal and side data that indicates a side of the device; and
compare the characteristic data and the side data to data stored in the database; and wherein, when selecting, the processor is further configured to execute the software to:
select the input based on a comparison.

11. The device of claim 8, wherein when determining the one or more sides, the processor is further configured to execute the software to:
determine the one or more sides based on the receipt of the ultrasonic signal that propagated on the user's body and effected by the on-body action, wherein a frequency of the ultrasonic signal received maps to a side of the device.

12. The device of claim 8, wherein, when analyzing, the processor is further configured to execute the software to:
analyze a frequency and an amplitude of the ultrasonic signal received; and
identify the on-body action based on an analysis of the frequency and the amplitude of the ultrasonic signal received.

13. The device of claim 8, further comprising:
a display, and wherein the on-body action is a multi-touch action or a multi-gesture action in which each touch or each gesture is performed on different sides of the device simultaneously, and wherein, when determining, the processor is further configured to execute the software to:
determine one side of the device that a touch of the multi-touch action or a gesture of the multi-gesture action is performed relative to the device, and
determine another side of the device that another touch of the multi-touch action or another gesture of the multi-gesture action is performed relative to the device.

14. The device of claim 8, wherein when determining the one or more sides, the processor is further configured to execute the software to:
determine the one or more sides based on an arrival time of the ultrasonic signal that propagated on the user's body and effected by the on-body action.

15. The device of claim 8, wherein the software comprises a machine learning module that allows the user to train the device to recognize particular on-body actions performed by the user and select inputs corresponding to the on-body actions.

16. A non-transitory storage medium that stores instructions executable by a processor of a computational device, which when executed, cause the computational device to:
analyze a characteristic of an ultrasonic signal that propagated on a body of a user of the computational device and effected by an on-body action, performed by the user, in an area in which the ultrasonic signal has propagated;
determine one or more sides of the computational device at which the on-body action is performed relative to the computational device;
select an input based on an analysis of the ultrasonic signal and the one or more sides; and
perform an action specified by the input.

17. The non-transitory storage medium of claim 16, wherein the instructions to determine comprise instructions to:
determine the one or more sides based on a receipt of the ultrasonic signal that propagated on the body of the user and effected by the on-body action, wherein a frequency of the ultrasonic signal received maps to a side of the computational device.

18. The non-transitory storage medium of claim 16, wherein the instructions comprise instructions to:
store a database that maps ultrasonic signal profiles to inputs; and
use the database to select the input.

19. The non-transitory storage medium of claim 16, wherein the instructions to determine comprise instructions to:
determine the one or more sides based on an arrival time of the ultrasonic signal that propagated on the body of the user and effected by the on-body action.

20. The non-transitory storage medium of claim 16, wherein the on-body action is a multi-touch action or a multi-gesture action.
